(19) United States
(12) Patent Application Publication
(10) Pub. No.: US 2021/0031775 A1
(43) Pub. Date: Feb. 4, 2021

(54) ROAD SURFACE FLOODING DETERMINATION DEVICE

(71) Applicant: AISIN SEIKI KABUSHIKI KAISHA, Kariya-shi (JP)

(72) Inventors: Hiroshi NOMA, Kariya-shi (JP); Yuhei MORI, Kariya-shi (JP); Eiji NIWA, Kariya-shi (JP)

(73) Assignee: AISIN SEIKI KABUSHIKI KAISHA, Kariya-shi (JP)

(21) Appl. No.: 16/841,763

(22) Filed: Apr. 7, 2020

(30) Foreign Application Priority Data
Jul. 29, 2019 (JP) 2019-138633

(51) Int. Cl. B60W 40/06; B60W 40/10; G01C 21/28

(52) U.S. Cl. CPC B60W 40/06; G01C 21/28; B60W 40/10

(57) ABSTRACT

A road surface flooding determination device includes: a traveling data acquisition unit configured to acquire an actual acceleration that is applied in a front-rear direction of a vehicle and is detected by an acceleration sensor; and a determination unit configured to calculate a theoretical acceleration which is a theoretical acceleration applied in the front-rear direction of the vehicle traveling on a road surface that is not flooded, and to determine whether or not a traveling position of the vehicle is a flooding location based on a difference between the actual acceleration and the theoretical acceleration.

### CROSS REFERENCE TO RELATED APPLICATIONS

This application is based on and claims priority under 35 U.S.C. § 119 to Japanese Patent Application 2019-138633, filed on Jul. 29, 2019, the entire contents of which are incorporated herein by reference.

### TECHNICAL FIELD

This disclosure relates to a road surface flooding determination device.

### BACKGROUND DISCUSSION

JP 2017-24460A (Reference 1) discloses a technique for determining whether or not flooding occurs on a road surface on which a vehicle travels based on a difference between an actual acceleration which is an acceleration calculated based on a vehicle speed of the vehicle and a theoretical acceleration which is an acceleration theoretically calculated based on a drive torque transmitted to wheels of the vehicle is developed. In addition, it is determined that the flooding occurs on the road surface on which the vehicle travels, when a difference between a change amount in the actual acceleration per predetermined time and a change amount in the theoretical acceleration per predetermined time increases in the technique.

However, the actual acceleration calculated based on the vehicle speed of the vehicle also changes due to a gradient of the road surface and the like, and therefore, when it is determined whether or not the road surface is flooded by using the actual acceleration calculated based on the vehicle speed, accuracy of determination may be reduced.

In addition, in the technique for determining whether or not the flooding occurs on the road surface by using the difference between the change amount in the actual acceleration per predetermined time and the change amount in the theoretical acceleration per predetermined time, when the change amount in the actual acceleration per predetermined time and the change amount in the theoretical acceleration per predetermined time do not occur, that is, when the drive torque and the vehicle speed of the vehicle traveling on the flooded road surface are constant, it is difficult to determine whether or not the flooding occurs on the road surface on which the vehicle travels. In addition, when the vehicle travels on a road surface with a changing gradient, the difference between the change amount in the actual acceleration per predetermined time and the change amount in the theoretical acceleration per predetermined time also increases, so that there is a possibility that the road surface is erroneously determined to be flooded.

Thus, a need exists for a road surface flooding determination device which is not susceptible to the drawback mentioned above.

### SUMMARY

A road surface flooding determination device according to an aspect of this disclosure includes, as an example, a traveling data acquisition unit configured to acquire an actual acceleration that is applied in a front-rear direction of a vehicle and is detected by an acceleration sensor; and a determination unit configured to calculate a theoretical acceleration which is a theoretical acceleration applied in the front-rear direction of the vehicle traveling on a road surface that is not flooded, and to determine whether or not a traveling position of the vehicle is a flooding location based on a difference between the actual acceleration and the theoretical acceleration.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary schematic configuration diagram illustrating a configuration of a road surface flooding determination system applied to a road surface flooding determination device according to a first embodiment;

FIG. 2 is a flowchart illustrating an example of a flow of a process for calculating a water depth at a flooding location by a vehicle according to the first embodiment;

FIG. 3 is a flowchart illustrating an example of a flow of a process for creating an acceleration map by the vehicle according to a second embodiment; and

FIG. 4 is a flowchart illustrating an example of a flow of a process for calculating a water depth at a flooding location by the vehicle according to the second embodiment.

### DETAILED DESCRIPTION

Hereinafter, embodiments disclosed here will be described. A configuration of the embodiments described below, and operations, results, and effects provided by the configuration are examples. This disclosure can be implemented by configurations other than those disclosed in the following embodiments, and can obtain at least one of various effects based on the basic configuration and derivative effects.

### Embodiment 1

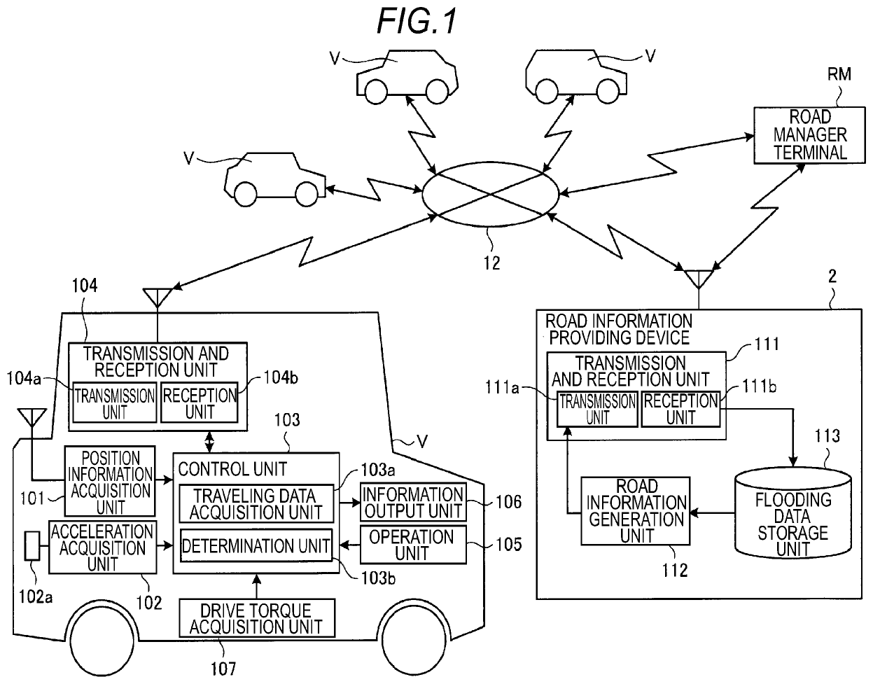

FIG. 1 is an exemplary schematic configuration diagram illustrating a configuration of a road surface flooding determination system applied to a road surface flooding determination device according to the first embodiment.

Firstly, an example of the configuration of the road surface flooding determination system according to the present embodiment will be described with reference to FIG. 1.

As illustrated in FIG. 1, the road surface flooding determination system according to the present embodiment includes a plurality of vehicles V, a road information providing device 2, and a road manager terminal RM. The plurality of vehicles V, the road information providing device 2, and the road manager terminal RM are connected via a network 12.

As illustrated in FIG. 1, the vehicle V includes an acceleration sensor 102a, an operation unit 105, and an information output unit 106.

The acceleration sensor 102a acquires an effective acceleration (hereinafter, referred to as an actual acceleration) applied to the vehicle V in a front-rear direction. As the acceleration sensor 102a, for example, an acceleration sensor used for detecting attitude of the vehicle V, detecting a side slip or the like, or an acceleration sensor that detects an impact and is used for an airbag system or the like may be used.

The operation unit 105 receives various operations performed on the vehicle V by an occupant of the vehicle V. For example, the operation unit 105 receives an acquisition request for acquiring road information such as road surface flooding information generated by the road information providing device 2. Here, the road surface flooding information is information related to flooding of a road surface, such as a location (hereinafter, referred to as a flooding location) where flooding occurs on a road on which the vehicle V travels, a water depth of the flooding location or the like.

The information output unit 106 is a display unit that displays the road information received from the road information providing device 2 in a manner visually observable for the occupant of the vehicle V, or a sound output unit that outputs the road information by voice or the like in response to the acquisition request received by the operation unit 105.

Further, the vehicle V has hardware such as a processor and a memory, and the processor reads and executes a program stored in the memory to implement various functional modules. As illustrated in FIG. 1, the vehicle V includes, as the functional modules, a position information acquisition unit 101, an acceleration acquisition unit 102, a control unit 103, a transmission and reception unit 104, a drive torque acquisition unit 107 and the like.

In the present embodiment, the position information acquisition unit 101, the acceleration acquisition unit 102, the control unit 103, the transmission and reception unit 104, and the drive torque acquisition unit 107 are implemented by the processor reading and executing the program stored in the memory, but the present disclosure is not limited to this.

For example, the position information acquisition unit 101, the acceleration acquisition unit 102, the control unit 103, the transmission and reception unit 104, and the drive torque acquisition unit 107 may be implemented by independent hardware. Further, the position information acquisition unit 101, the acceleration acquisition unit 102, the control unit 103, the transmission and reception unit 104, and the drive torque acquisition unit 107 are examples, and as long as same functions can be implemented, each of the functional modules may be integrated or subdivided.

The position information acquisition unit 101 acquires position information indicating a traveling position (current position) of the vehicle V. The position information acquisition unit 101 acquires the position information of the vehicle V by using, for example, a global positioning system (GPS) or the like. Alternatively, the position information acquisition unit 101 may acquire the position information of the vehicle V by another system such as a navigation system mounted on the vehicle V.

The acceleration acquisition unit 102 acquires the actual acceleration detected by the acceleration sensor 102a. The acceleration acquisition unit 102 acquires, for example, the actual acceleration applied to the vehicle V in the front-rear direction from the acceleration sensor 102a which is already mounted on the vehicle V.

The drive torque acquisition unit 107 acquires drive torque of the vehicle V. In the present embodiment, the drive torque acquisition unit 107 acquires the drive torque applied to wheels of the vehicle V from a drive unit (for example, an electric motor or an engine) of the vehicle V.

The control unit 103 is an example of a control unit that controls the entire vehicle V.

Specifically, the control unit 103 controls a transmission unit 104a, which will be described later, and controls transmission of various types of information to an external device (for example, the road information providing device 2, or the road manager terminal RM).

In the present embodiment, the control unit 103 controls the transmission unit 104a, which will be described later, and transmits flooding data indicating execution results of a flooding determination process and a water depth calculation process to the road information providing device 2. Here, the flooding determination process is a process of determining whether or not the traveling position of the vehicle V is the flooding location. In addition, the water depth calculation process is a process of calculating a water depth of the flooding location.

Further, in the present embodiment, the control unit 103 controls the transmission unit 104a, which will be described later, and transmits the acquisition request of the road information received by the operation unit 105 to the road information providing device 2.

Further, the control unit 103 controls a reception unit 104b, which will be described later, to receive various information from the external device (for example, the road information providing device 2 or the road manager terminal RM). In the present embodiment, the control unit 103 controls the reception unit 104b, which will be described later, to receive the road information from the road information providing device 2.

Further, the control unit 103 outputs the road information such as the road surface flooding information received from the road information providing device 2 to the information output unit 106.

Further, the control unit 103 controls the vehicle V based on various operations received by the operation unit 105.

The transmission and reception unit 104 is a communication unit that manages communication with the external device such as the road information providing device 2 and the road manager terminal RM that are connected to each other via the network 12. In the present embodiment, the transmission and reception unit 104 includes the transmission unit 104a and the reception unit 104b.

The transmission unit 104a transmits the flooding data to the road information providing device 2 via the network 12. Further, the transmission unit 104a transmits the acquisition request of the road information that is received by the operation unit 105 to the road information providing device 2 via the network 12.

The reception unit 104b receives, via the network 12, the road information transmitted from the road information providing device 2.

Next, an example of a specific functional configuration related to the flooding determination process and the water depth calculation process among functional configurations of the control unit 103 of the vehicle V will be described with reference to FIG. 1.

As illustrated in FIG. 1, the control unit 103 of the vehicle V includes a traveling data acquisition unit 103a and a determination unit 103b.

The traveling data acquisition unit 103a is an acquisition unit that acquires traveling data of the vehicle V.

Here, the traveling data is data indicating a traveling state of the vehicle V. In the present embodiment, the traveling data includes the actual acceleration acquired by the acceleration acquisition unit 102, the drive torque acquired by the drive torque acquisition unit 107, the position information acquired by the position information acquisition unit 101, a current time measured by a time measuring unit (not shown) (for example, RTC: real time clock), an accelerator opening of the vehicle V, a vehicle speed of the vehicle V, an intake air amount and a fuel injection amount of the drive unit (engine) of the vehicle V and the like. The accelerator opening is a value indicating an operation amount of an accelerator operation unit (for example, an accelerator pedal) of the drive unit (for example, an electric motor or an engine) of the vehicle V.

The determination unit 103b calculates a theoretical acceleration (hereinafter, referred to as a theoretical acceleration) of the vehicle V. Here, the theoretical acceleration is an acceleration theoretically applied in the front-rear direction on the vehicle V traveling on a road surface that is not flooded. In the present embodiment, the determination unit 103b calculates the theoretical acceleration based on the drive torque acquired by the traveling data acquisition unit 103a.

Next, the determination unit 103b calculates a difference between the calculated theoretical acceleration and the actual acceleration acquired by the traveling data acquisition unit 103a. Then, the determination unit 103b determines whether or not a traveling location of the vehicle V is the flooding location based on the difference between the theoretical acceleration and the actual acceleration. In the present embodiment, when the difference between the theoretical acceleration and the actual acceleration is equal to or greater than a predetermined threshold value, the determination unit 103b determines that the traveling location of the vehicle V is the flooding location. Here, the predetermined threshold value is a threshold value of a difference between the theoretical acceleration and the actual acceleration, at which it is determined that flooding occurs on the road surface.

Thus, it is possible to determine whether or not the traveling position of the vehicle V is the flooding location in consideration of influence of the acceleration to be applied to the vehicle V due to a gradient of the road surface. As a result, it is possible to improve accuracy of determining whether or not the traveling position of the vehicle V is the flooding location.

Specifically, when the vehicle V is traveling on the road surface that is not flooded, a relationship among a drive torque T, a travel resistance R (travel resistance of the vehicle V traveling on a flat (horizontal) road surface that is not flooded), and a theoretical acceleration G of the vehicle V can be expressed by the following equation (1).

T−R=M×G (1)

Here, M is a weight of the vehicle V. The travel resistance R of the vehicle V is a force other than a force generated by the drive torque among forces applied to the vehicle V.

On the other hand, when the vehicle V is traveling on a road surface having a gradient (for example, an upslope), the vehicle V is affected by a gravity resistance force Fg. Therefore, a relationship among the drive torque T, the travel resistance R, the theoretical acceleration G, and the gravity resistance force Fg can be expressed by the following equation (2). Further, the gravity resistance force Fg can be expressed by the following equation (3).

T−R−Fg=M×G (2)

Fg=M×g×sin θ (3)

Here, g is a gravitational acceleration.

Further, when the vehicle V is traveling on the road surface having the gradient, an actual acceleration Gx detected by the acceleration sensor 102a of the vehicle V is influenced by the gravitational acceleration g, and thus can be expressed by the following equation (4).

g×sin θ=Gx−G (4)

Then, when the equation (4) is substituted into the equation (3), the gravity resistance force Fg can be expressed by the following equation (5).

Fg=M×(Gx−G) (5)

Further, when the equation (5) is substituted into the equation (2), a relationship among the drive torque T, the travel resistance R and the actual acceleration Gx can be expressed by the following equation (6).

T−R=M×Gx (6)

Further, when the equation (6) is divided by the weight M of vehicle V, the relationship among the drive torque T, the travel resistance R and the actual acceleration Gx can be expressed by the following equation (7).

Gx=(1/M)×T−R/M (7)

According to the equation (7), the theoretical acceleration G can be independently acquired based on the drive torque T regardless of presence or absence of the gradient of the road surface on which the vehicle V travels.

Therefore, in the present embodiment, the determination unit 103b determines whether or not the traveling position of the vehicle V is the flooding location based on a difference between the theoretical acceleration G (the theoretical acceleration G calculated by using a right side of the equation (7) in the present embodiment) which is calculated based on the drive torque T, and the actual acceleration Gx. Thus, it is possible to determine whether or not the traveling position of the vehicle V is the flooding location in consideration of the influence of the acceleration to be applied to the vehicle V due to the gradient of the road surface. As a result, it is possible to improve the accuracy of determining whether or not the traveling position of the vehicle V is the flooding location.

In addition, the determination unit 103b calculates a traveling resistance force, which is the traveling resistance of the vehicle V due to the flooding of the road surface, based on the difference between the theoretical acceleration and the actual acceleration. Next, the determination unit 103b uses the traveling resistance force of the vehicle V and the vehicle speed of the vehicle V acquired by the traveling data acquisition unit 103a to calculate an area of a part of a frontal projected area of the vehicle V that is immersed in water (hereinafter, referred to as an immersion area). Here, the frontal projected area is an area of a shadow when the vehicle V is projected onto a two-dimensional projection surface from the front (in other words, an area of the vehicle V when the vehicle V is viewed from the front surface).

Then, the determination unit 103b calculates the water depth of the flooding location based on the calculated immersion area. Thus, it is possible to calculate the immersion area of the vehicle V in consideration of the influence of the acceleration to be applied to the vehicle V due to the gradient of the road surface. As a result, accuracy of calculating the water depth at the flooding location can be improved.

Specifically, a traveling resistance force Fw of the vehicle V when the vehicle V travels at the flooding location can be expressed by the following equation (8).

Fw=(½)×ρ×Cd×A×v2 (8)

Here, ρ is a density of water, Cd is a coefficient different for each vehicle V, A is the immersion area, and v is the vehicle speed of the vehicle V.

In a right side of equation (8), terms other than the immersion area A and the vehicle speed v are constants. The immersion area A is determined by the water depth of the flooding location. That is, it can be seen that the traveling resistance force Fw that increases when the vehicle V travels at the flooding location is determined by the water depth of the flooding location and the vehicle speed v of the vehicle V.

Therefore, the determination unit 103b calculates the immersion area A based on the traveling resistance force Fw of the vehicle V and the vehicle speed v of the vehicle V, and calculates the water depth of the flooding location based on the calculated immersion area A.

Further, the determination unit 103b generates the flooding data indicating the position information (the traveling position of the vehicle V) acquired by the position information acquisition unit 101, the current time measured by the RTC, a determination result of whether or not the traveling position of the vehicle V is the flooding location, and a calculation result of the water depth of the flooding location.

In the present embodiment, an example in which the road surface flooding determination device is provided in the vehicle V is described, but the road surface flooding determination device may also be provided in the external device (for example, the road information providing device 2 or the road manager terminal RM) that can acquire the traveling data of the vehicle V.

Next, an example of a functional configuration of the road information providing device 2 will be described with reference to FIG. 1.

For example, the road information providing device 2 is provided in a base station that can wirelessly communicate with an edge, a cloud, and the vehicle V. The road information providing device 2 includes a personal computer having the hardware such as the processor and the memory.

Specifically, the road information providing device 2 includes a transmission and reception unit 111, a road information generation unit 112 and a flooding data storage unit 113. In the present embodiment, the processor reads and executes a program stored in the memory, such that the road information providing device 2 implements various functional modules of the transmission and reception unit 111, the road information generation unit 112 and the like.

In the present embodiment, the various functional modules such as the transmission and reception unit 111, the road information generation unit 112 and the like are implemented by the processor reading and executing the program stored in the memory, but the disclosure is not limited to this. For example, the various functional modules such as the transmission and reception unit 111, the road information generation unit 112 and the like can be implemented by independent hardware. Further, the various functional modules such as the transmission and reception unit 111, the road information generation unit 112 and the like are examples, and as long as same functions can be implemented, each of the functional modules may be integrated or subdivided.

The flooding data storage unit 113 is a storage unit that is implemented by the memory included in the road information providing device 2 and stores the flooding data received by a reception unit 111b described below.

The transmission and reception unit 111 is a communication unit that manages communication with the external device such as the vehicle V and the road manager terminal RM that are connected via the network 12. In the present embodiment, the transmission and reception unit 111 includes a transmission unit 111a and the reception unit 111b.

The transmission unit 111a transmits various information such as the road information to the vehicle V or the road manager terminal RM via the network 12.

The reception unit 111b receives the flooding data from the vehicle V via the network 12. Then, the reception unit 111b writes the received flooding data to the flooding data storage unit 113.

The road information generation unit 112 generates the road information such as the road surface flooding information. Specifically, the road information generation unit 112 generates, as the road surface flooding information, a database in which the traveling position of the vehicle V, the determination result of whether or not the traveling position is the flooding location, and the calculation result of the water depth of the flooding location are associated, based on the flooding data stored in the flooding data storage unit 113.

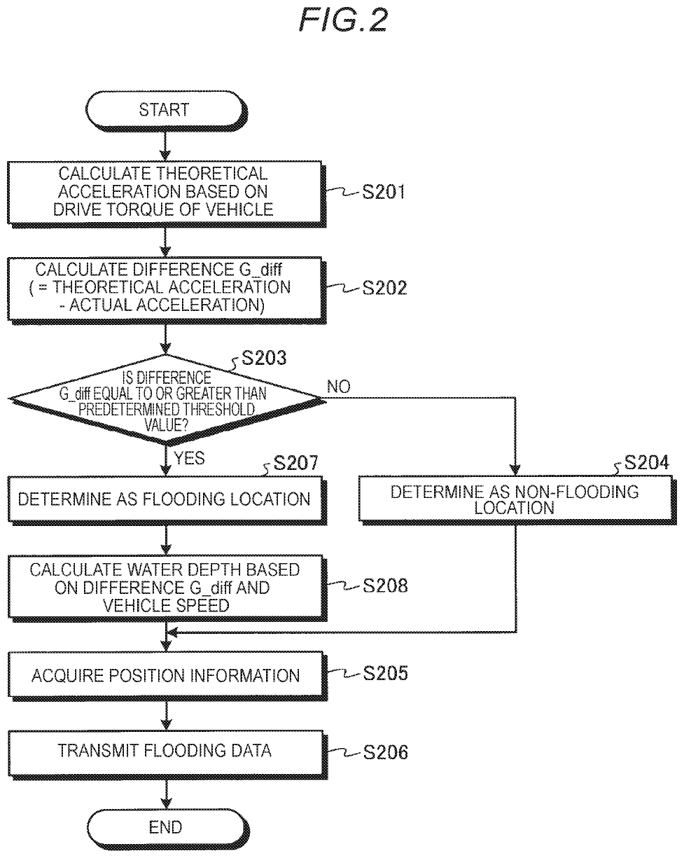

FIG. 2 is a flowchart illustrating an example of a flow of a process for calculating the water depth at the flooding location by the vehicle according to the first embodiment.

Next, the example of the flow of the process for calculating the water depth at the flooding location by the vehicle V according to the present embodiment will be described with reference to FIG. 2.

Firstly, the traveling data acquisition unit 103a acquires the drive torque of the vehicle V. In the present embodiment, the traveling data acquisition unit 103a acquires the drive torque of the vehicle V based on a detection result of the drive torque obtained by a torque sensor of the vehicle V, the intake air amount and the fuel injection amount of the drive unit (engine) of the vehicle V, the accelerator opening of the vehicle V, the vehicle speed of the vehicle V, the drive torque output from a motor (electric motor) for driving the vehicle V and the like.

The determination unit 103b calculates the theoretical acceleration based on the drive torque acquired by the traveling data acquisition unit 103a (step S201). Next, the determination unit 103b calculates a difference G_diff between the calculated theoretical acceleration and the actual acceleration acquired by the traveling data acquisition unit 103a (step S202). Then, the determination unit 103b determines whether or not the difference G_diff is equal to or greater than the predetermined threshold value (step S203).

When the difference G_diff is less than the predetermined threshold value (step S203: No), the determination unit 103b determines that the traveling position of the vehicle V is a non-flooding location where the flooding does not occur (step S204). The traveling data acquisition unit 103a acquires the position information acquired by the position information acquisition unit 101 (step S205). Further, the transmission unit 104a transmits the flooding data indicating the position information acquired by the traveling data acquisition unit 103a and a determination result of whether or not the traveling position of the vehicle V indicated by the position information is the flooding location (that the traveling position of the vehicle V is the non-flooding location), to the road information providing device 2 via the network 12 (step S206).

On the other hand, when the difference G_diff is equal to or greater than the predetermined threshold value (step S203: Yes), the determination unit 103b determines that the traveling position of the vehicle V is the flooding location where the flooding occurs (step S207). In this case, the determination unit 103b calculates the water depth of the flooding location based on the difference G_diff and the vehicle speed of the vehicle V (step S208). The traveling data acquisition unit 103a acquires the position information acquired by the position information acquisition unit 101 (step S205).

Then, the transmission unit 104a transmits, to the road information providing device 2 via the network 12, the flooding data indicating the position information acquired by the traveling data acquisition unit 103a, the determination result of whether or not the traveling position of the vehicle V indicated by the position information is the flooding location, which is the traveling position of the vehicle V is the flooding location, and the calculation result of the water depth of the flooding location (step S206).

Thus, according to the vehicle V of the first embodiment, it is possible to determine whether or not the traveling position of the vehicle V is the flooding location in consideration of the influence of the acceleration to be applied to the vehicle V due to the gradient of the road surface. As a result, it is possible to improve the accuracy of determining whether or not the traveling position of the vehicle V is the flooding location.

### Embodiment 2

The present embodiment is an example in which the theoretical acceleration is calculated based on the accelerator opening of the vehicle and the vehicle speed of the vehicle. In the following description, a description of the same configuration as in the first embodiment will be omitted.

In the present embodiment, the vehicle V includes a storage unit that can store an acceleration map. Here, the acceleration map is a database in which a combination of the accelerator opening and the vehicle speed of the vehicle V in a case where the vehicle V is traveling on a road surface that is not flooded, and a candidate of an acceleration (hereinafter, referred to as acceleration candidate) to be applied in the front-rear direction of the vehicle V which is obtained by a regression analysis using the combination are associated. Here, the accelerator opening is a value indicating an operation amount of an acceleration operation unit (accelerator pedal) of the drive unit (for example, an electric motor or an engine) of the vehicle V.

In the present embodiment, the traveling data acquisition unit 103a acquires the accelerator opening and the vehicle speed of the vehicle V.

In the present embodiment, the determination unit 103b calculates the theoretical acceleration based on the combination of the accelerator opening and the vehicle speed acquired by the traveling data acquisition unit 103a. Specifically, the determination unit 103b calculates, as the theoretical acceleration, an acceleration candidate associated with the combination of the accelerator opening and the vehicle speed acquired by the traveling data acquisition unit 103a in the acceleration map.

Thus, it is possible to determine whether or not the traveling position of the vehicle V is the flooding location and to calculate the water depth of the flooding location in consideration of the influence of the acceleration to be applied to the vehicle V due to the gradient of the road surface. As a result, it is possible to improve the accuracy of determining whether or not the traveling position of the vehicle V is the flooding location and the accuracy of calculating the water depth of the flooding location.

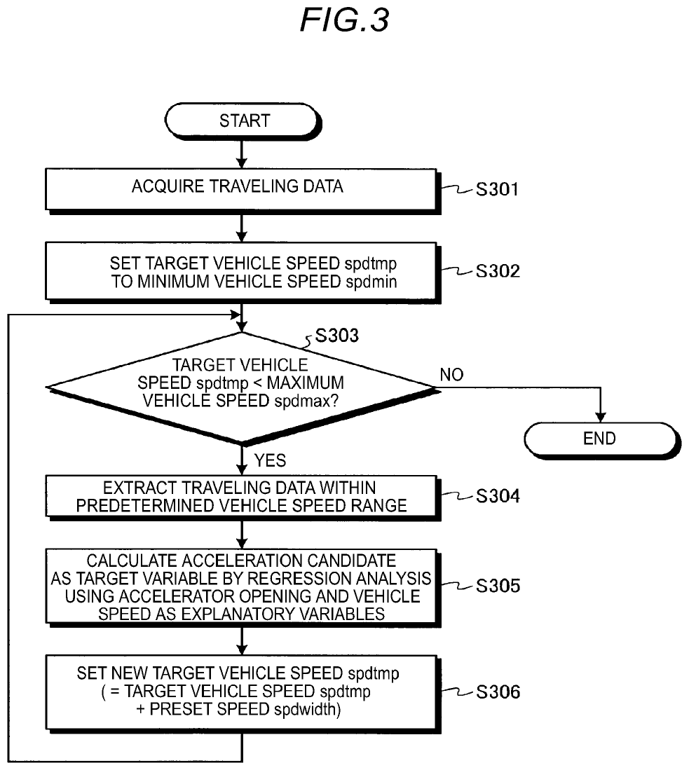

FIG. 3 is a flowchart illustrating an example of a flow of a process for creating the acceleration map by the vehicle according to the second embodiment.

Next, the example of the flow of the process for creating the acceleration map by the vehicle V according to the present embodiment will be described with reference to FIG. 3.

The traveling data acquisition unit 103a acquires the traveling data (the accelerator opening and the vehicle speed of the vehicle V) when the vehicle V travels on the road surface where the flooding does not occur (step S301).

The determination unit 103b sets a vehicle speed spdtmp for obtaining the acceleration of the vehicle V (hereinafter referred to as target vehicle speed) to a minimum vehicle speed spdmin among the vehicle speeds for obtaining the acceleration candidate (step S302).

Next, the determination unit 103b determines whether or not the set target vehicle speed spdtmp is lower than a maximum vehicle speed spdmax among the vehicle speeds for obtaining the acceleration candidate (step S303).

When it is determined that the target vehicle speed spdtmp is equal to or higher than the maximum vehicle speed spdmax (step S303: No), the determination unit 103b ends creation of the acceleration map.

On the other hand, when it is determined that the target vehicle speed spdtmp is lower than the maximum vehicle speed spdmax (step S303: Yes), the determination unit 103b extracts traveling data when the vehicle V travels at a vehicle speed within a predetermined vehicle speed range from the traveling data acquired by the traveling data acquisition unit 103a (step S304). Here, the predetermined vehicle speed range is a range that is equal to or higher than the target vehicle speed spdtmp and lower than a vehicle speed that is faster than the target vehicle speed spdtmp by a preset speed spdwidth.

Next, the determination unit 103b estimates the acceleration candidate as a target variable by the regression analysis using the accelerator opening and the vehicle speed included in the extracted traveling data as explanatory variables (step S305). Then, the determination unit 103b creates the acceleration map in which the combination of the accelerator opening and the vehicle speed as the explanatory variables is associated with the estimated acceleration candidate.

Next, the determination unit 103b sets a vehicle speed obtained by adding the preset speed spdwidth to the target vehicle speed spdtmp as a new target vehicle speed spdtmp (step S306). Thereafter, the determination unit 103b returns to step S303, determines whether or not the new target vehicle speed spdtmp is the maximum vehicle speed spdmax, and when it is determined that the new target vehicle speed spdtmp is not the maximum vehicle speed spdmax, steps S304 to S307 are repeated.

In the present embodiment, an example in which the acceleration map is created in the vehicle V is described, but the acceleration map may also be created in the external device (for example, the road information providing device 2 or the road manager terminal RM) that can acquire the traveling data of the vehicle V, and the created acceleration map is transmitted to the vehicle V.

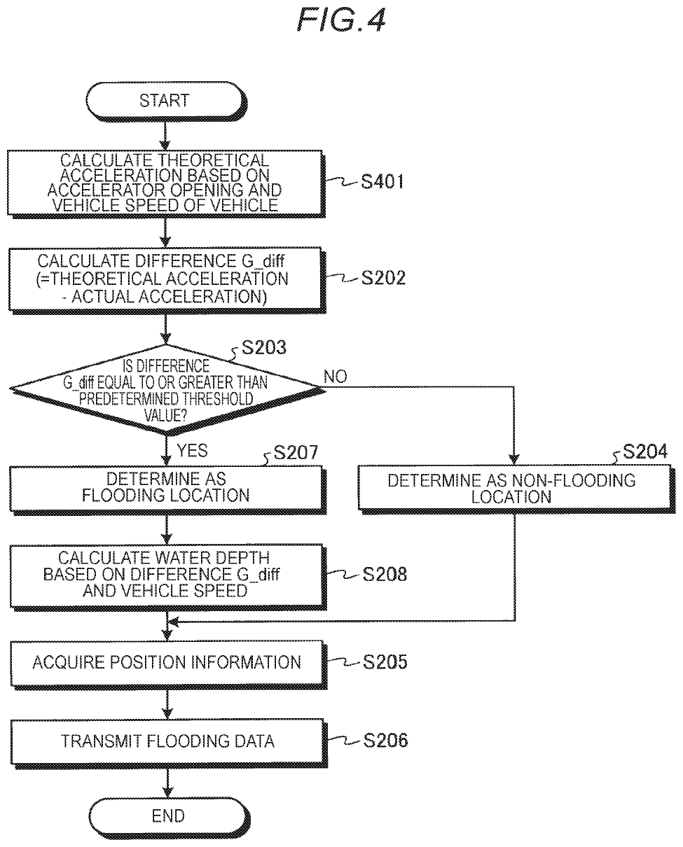

FIG. 4 is a flowchart illustrating an example of a flow of a process for calculating the water depth at the flooding location by the vehicle according to the second embodiment.

Next, the example of the flow of the process for calculating the water depth at the flooding location by the vehicle V according to the present embodiment will be described with reference to FIG. 4. In the following description, a step different from the step illustrated in FIG. 2 will be described.

Firstly, the traveling data acquisition unit 103a acquires the accelerator opening and the vehicle speed of the vehicle V. Next, the determination unit 103b acquires, as the theoretical acceleration, an acceleration candidate associated with the combination of the accelerator opening and the vehicle speed acquired by the traveling data acquisition unit 103a in the acceleration map (step S401).

Thus, according to the vehicle V of the second embodiment, it is possible to determine whether or not the traveling position of the vehicle V is the flooding location and to calculate the water depth of the flooding location in consideration of the influence of the acceleration to be applied to the vehicle V due to the gradient of the road surface. As a result, it is possible to improve the accuracy of determining whether or not the traveling position of the vehicle V is the flooding location and the accuracy of calculating the water depth of the flooding location.

A road surface flooding determination device according to an aspect of this disclosure includes, as an example, a traveling data acquisition unit configured to acquire an actual acceleration that is applied in a front-rear direction of a vehicle and is detected by an acceleration sensor; and a determination unit configured to calculate a theoretical acceleration which is a theoretical acceleration applied in the front-rear direction of the vehicle traveling on a road surface that is not flooded, and to determine whether or not a traveling position of the vehicle is a flooding location based on a difference between the actual acceleration and the theoretical acceleration. Therefore, as one example, it is possible to improve accuracy of determining whether or not the traveling position of the vehicle is the flooding location.

In the road surface flooding determination device, as an example, the traveling data acquisition unit may further acquire a vehicle speed of the vehicle, and the determination unit may further calculate an immersion area of a part of a frontal projected area of the vehicle that is immersed in water using the vehicle speed of the vehicle and a traveling resistance force of the vehicle based on the difference, and calculates a water depth at the flooding location based on the immersion area. Therefore, as one example, accuracy of calculating the water depth at the flooding location can be improved.

In the road surface flooding determination device, as an example, the traveling data acquisition unit may further acquire a drive torque of the vehicle, and the determination unit may calculate the theoretical acceleration based on the drive torque. Therefore, as one example, it is possible to improve accuracy of determining whether or not the traveling position of the vehicle is the flooding location.

As an example, the road surface flooding determination device may further include a storage unit that stores an acceleration map in which a combination of an accelerator opening and a vehicle speed of the vehicle traveling on a road surface that is not flooded is associated with an acceleration candidate applied in the front-rear direction of the vehicle which is obtained by regression analysis using the combination, in which the traveling data acquisition unit may be configured to acquire an accelerator opening of the vehicle and a vehicle speed of the vehicle, and the determination unit may be configured to calculate, as the theoretical acceleration, an acceleration candidate associated with a combination of the accelerator opening and the vehicle speed of the vehicle which is acquired by the traveling data acquisition unit in the acceleration map. Therefore, as one example, it is possible to improve the accuracy of determining whether or not the traveling position of the vehicle is the flooding location and the accuracy of calculating the water depth of the flooding location.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A road surface flooding determination device, comprising:
a traveling data acquisition unit configured to acquire an actual acceleration that is applied in a front-rear direction of a vehicle and is detected by an acceleration sensor; and
a determination unit configured to calculate a theoretical acceleration which is a theoretical acceleration applied in the front-rear direction of the vehicle traveling on a road surface that is not flooded, and to determine whether or not a traveling position of the vehicle is a flooding location based on a difference between the actual acceleration and the theoretical acceleration.

2. The road surface flooding determination device according to claim 1, wherein
the traveling data acquisition unit further acquires a vehicle speed of the vehicle, and
the determination unit further calculates an immersion area of a part of a frontal projected area of the vehicle that is immersed in water using the vehicle speed of the vehicle and a traveling resistance force of the vehicle based on the difference, and calculates a water depth at the flooding location based on the immersion area.

3. The road surface flooding determination device according to claim 2, wherein
the traveling data acquisition unit further acquires a drive torque of the vehicle, and
the determination unit calculates the theoretical acceleration based on the drive torque.

4. The road surface flooding determination device according to claim 1, further comprising:
a storage unit that stores an acceleration map in which a combination of an accelerator opening and a vehicle speed of the vehicle traveling on a road surface that is not flooded is associated with an acceleration candidate applied in the front-rear direction of the vehicle which is obtained by regression analysis using the combination, wherein
the traveling data acquisition unit is configured to acquire an accelerator opening of the vehicle and a vehicle speed of the vehicle, and
the determination unit is configured to calculate, as the theoretical acceleration, an acceleration candidate associated with a combination of the accelerator opening and the vehicle speed of the vehicle which is acquired by the traveling data acquisition unit in the acceleration map.
